(19) United States
(12) Patent Application Publication
(10) Pub. No.: US 2020/0352116 A1
(43) Pub. Date: Nov. 12, 2020

(54) Frame mounted hydraulic cable log skidder industrial attachment for agricultural tractors

(71) Applicant: Richard James Alescio, Bainbridge Island, WA (US)

(72) Inventor: Richard James Alescio, Bainbridge Island, WA (US)

(21) Appl. No.: 16/501,604

(22) Filed: May 8, 2019

(51) Int. Cl. A01G 23/00; B66D 1/00; B66D 1/60

(52) U.S. Cl. CPC A01G 23/006; B66D 1/60; B66D 1/005

(57) ABSTRACT

This patent relates to a frame mounted hydraulic cable log skidder attachment for agricultural tractors. The skidder unit includes the structural plate, beam, and roller arch assembly which provides structural support for the hydraulic winch. The log skidder unit hydraulically self-loads onto the rear of the tractor. Once the log(s)/load is secured manually on the end of the choker cable, the load is raised off the ground via the hydraulic winch from inside the tractor cab and moved to a desired location, where the load is disconnected manually from the dismounted position.

### REFERENCES CITED

U.S. Patent Documents

| | | | |
|---|---|---|---|
| 4,278,392 | July 1981 | Meisel | 1212/255 |
| 4,460,160 | July 1984 | Tillotson | 254/327 |
| 4,529,350 | July 1985 | Jones | 414/494 |

### BACKGROUND OF THE INVENTION

### Field of the Invention

Art Unit: 3652

### Description of the Related Art

This invention relates to log skidders or the like for dragging heavy loads such as logs through rough terrain. A large special use log skidder is generally used for large commercial timber harvesting and logging operations. This agricultural tractor rear attachment allows the tractor to be used as a cable log skidder for smaller timber harvests, on an as needed basis, when not being used for agricultural purposes. Related art for agricultural rubber tired tractor attachments includes;

Rear three point hitch mounted cable winch units,

Powered off the rear mounted tractor integral splined shaft power take-off,

Which are operated to one side of the attachment by a rope,
Exposing the operator directly to a log pull line under tension while moving the load from where it was felled up to the back of the tractor,

The log end is then elevated for skidding over rough terrain or haul road,

Placing high loads on the three point hitch assembly,
And the winch under load cannot be operated manually when the tractor is moving, if required.

### BRIEF SUMMARY OF THE INVENTION

It is an object of the present invention to provide a removable self-loading winch-cable unit attachment, frame mounted (versus 3 point hitch mounted) loaded to the rear of an agricultural tractor for effectively securing and moving logs and other objects of varying sizes from their felled location.

It is an object of the present invention to operate the winch/log choker cable by a manually operated, tractor hydraulic powered, attachment mounted winch.

It is an object of the present invention to operate the winch/log choker cable from inside the tractor cab in front of a safety cage (versus a vulnerable position on the ground outside the cab).

It is another object of the invention to be able to adjust the winch choker cable length while the tractor is moving and under the load of a log(s).

Additional objects and advantages of this invention are apparent in descriptions following, referencing attached drawings.

### DESCRIPTION OF DRAWINGS

FIG. 1: A side view of the log skidding attachment secured to an agricultural tractor in addition to a load, according to the present invention. Also indicated is a removable counter weight for load balancing.

FIG. 2: A rear view of the skidder attachment mounted to the agricultural tractor hauling a log according to the present invention.

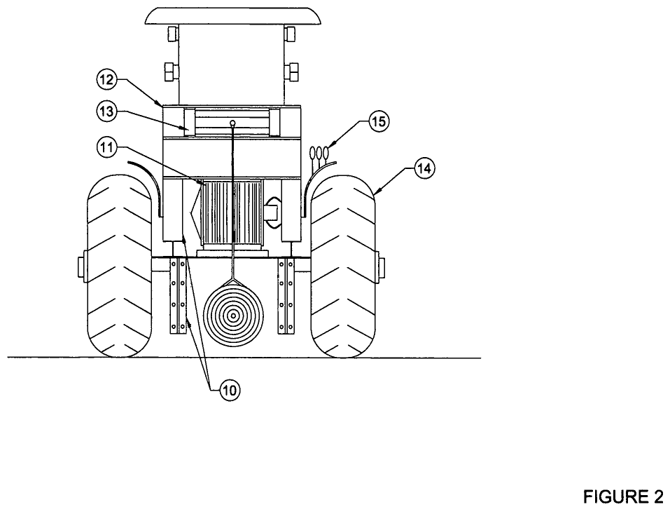

FIG. 3: A plan (top) view of the attachment secured to an agricultural tractor and a load with front removable counter weight, according to the present invention.

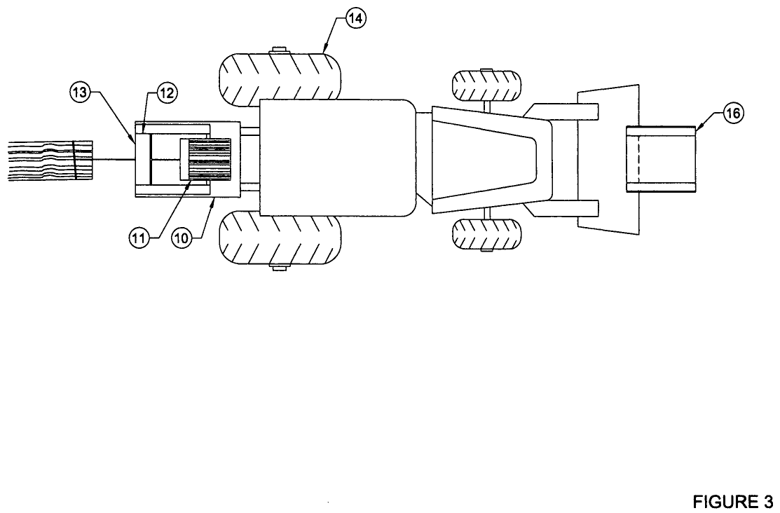

FIG. 4: A fragmentary (exploded) view illustrating a manner of interconnection between the skidder attachment, bed plate, structural frame, and hydraulic winch.

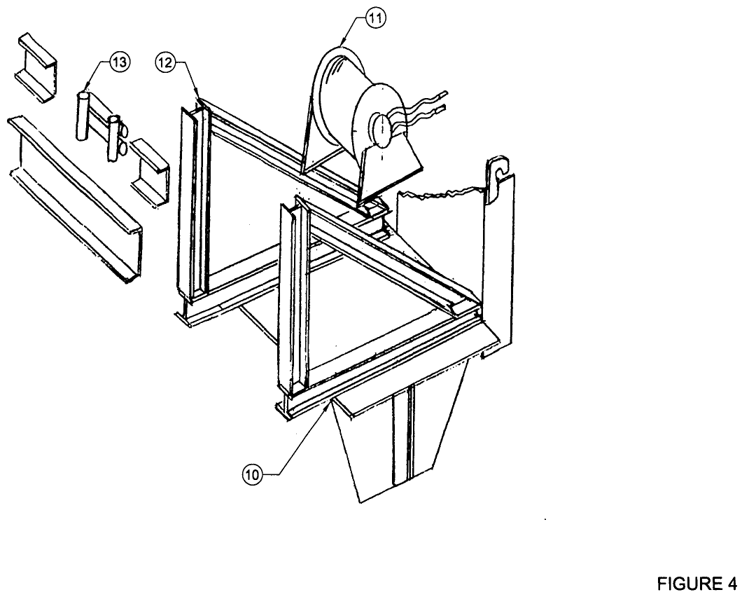

FIG. 5: Detailed side, back, and top views of a removable quick attach/detach front loader mounted counter weight.

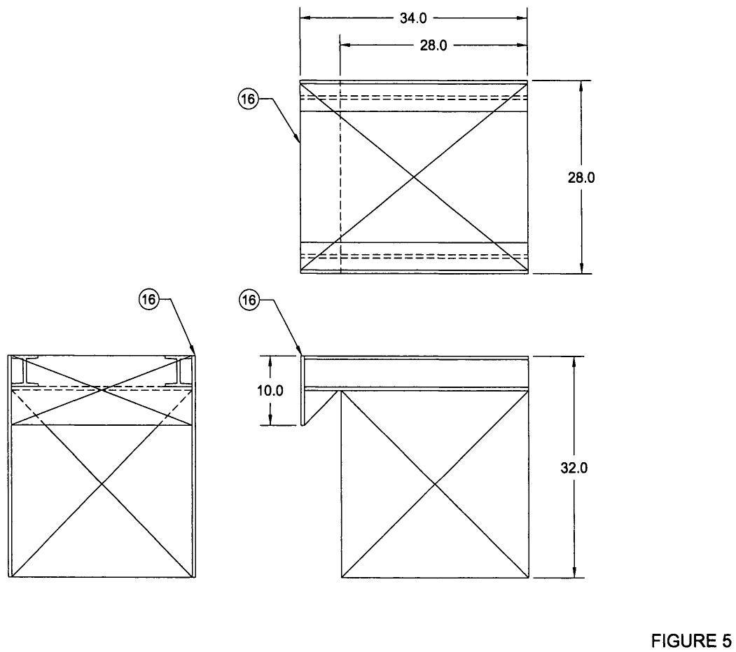

### DETAILED DESCRIPTION OF THE INVENTION

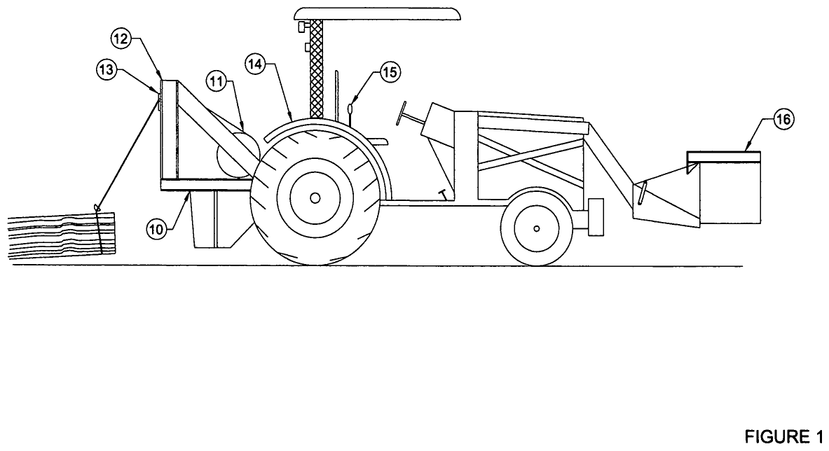

With particular reference to the drawings (see FIGS. 1,2,3,4,5)

An easily detachable augmented backhoe frame mounted log skidder attachment 10 with integral tractor hydraulic powered cable winch 11, with and integral: arch 12, and fairlead 13, which mounts to the rear end of a rubber tired agricultural tractor 14, utilizing existing tractor cab/fender mounted hydraulic lever controls 15 operated when moving or stopped.

The embodiments of the invention in which an exclusive property is claimed are defined as follows:

1-5. (canceled)

6. Detachable log skidder hydraulic winch and arch assembly and fairlead, for non three point hitch, detachable mounting to the rear frame of a rubber tired agricultural tractor.

7. Manual control of the integral hydraulic winch from the operators cab hydraulic lever controls when the tractor is stationary or moving under load.
